(19) United States
(12) Patent Application Publication
(10) Pub. No.: US 2021/0072187 A1
(43) Pub. Date: Mar. 11, 2021

(54) NON-DESTRUCTIVE INSPECTION DEVICE

(71) Applicant: NATIONAL UNIVERSITY CORPORATION OKAYAMA UNIVERSITY, Okayama-shi, Okayama (JP)

(72) Inventor: Keiji TSUKADA, Okayama-shi, Okayama (JP)

(21) Appl. No.: 16/642,564

(22) PCT Filed: Mar. 29, 2018
(86) PCT No.: PCT/JP2018/013461

§ 371 Date: Feb. 27, 2020

(30) Foreign Application Priority Data
Aug. 30, 2017 (JP) 2017-166273

(51) Int. Cl. G01N 27/90

(52) U.S. Cl. CPC G01N 27/9033

(57) ABSTRACT

Provided is a non-destructive inspection device for inspecting thinning produced in the vicinity of the ground of a to-be-inspected body, which is erected on a ground surface by burying the base-end side thereof in the ground. A non-destructive inspection device having: magnetic probes comprising impression coils that impress a magnetic field on a to-be-inspected body, which is erected on a ground surface by the base-end side thereof being buried in the ground, and magnetic sensors that detect a response from the to-be-inspected body with respect to the magnetic field impressed by the impression coils; a current source for supplying an AC current having a prescribed frequency to the impression coils; a detector for detecting an output signal from the magnetic sensors; and an analyzer for performing analysis using an output signal from the detector, wherein the non-destructive inspection device detects a response from the to-be-inspected body in a first mode in which the magnetic field generated by the impression coil is impressed toward the vicinity of the around of the to-be-inspected body and a second mode in which the magnetic field is impressed on the to-be-inspected body by the impression coil at a position different front the position of the impression coil in the first mode.

### TECHNICAL FIELD

The present invention relates to a non-destructive inspection device that magnetically inspects corrosion of a metal structure.

### BACKGROUND ART

Infrastructural structures made of steel materials are subject to deterioration over time, so that conducting inspections to ensure safety is a major social problem at present. Of these steel structures, there are many structures that are installed alongside the road, such as steel supports such as road indicator lights and lighting towers, and piers such as diagonal members of truss bridges and pedestrian bridges. In these steel structures, since the foundation is buried in soil or concrete, it has been known that water easily accumulates in the groundside portion, in particular, and that corrosion of steel materials easily occurs. Moreover, when the state where the corrosion occurred is left as it is, shaking caused by strong typhoons and earthquakes may cause damage from corroded areas, so that traffic obstruction may occur or in the worst case, a traffic accident may occur. For this reason, the steel structure is regularly inspected for deterioration such as corrosion. In particular, in order to inspect a buried part, excavation of soil or concrete was also performed. For this reason, a lot of time and effort is required for inspection of a steel structure, and a method that can be easily inspected has been desired.

The following method is known as a method for inspecting a decrease in wall thickness due to corrosion of a steel material in a steel structure. For example, there is a method of measuring the wall thickness by generating an ultrasonic wave in a steel material above the groundside portion using an ultrasonic generator constituted by a high-frequency coil and an electromagnet (for example, Non-Patent Literature 1). Another method is to measure the thickness of a metal by performing a frequency analysis after applying a pulse magnetic field (Patent Literature 1). Alternatively, a method is known in which by applying multiple frequencies to the steel material, and measuring the phase change of the magnetic field vector at two frequencies, measurement can be performed even for thick steel plates without being affected by magnetic noise due to the magnetic permeability or magnetization of a magnetic body such as a steel plate of a to-be-inspected body, which has been a problem in conventional magnetic measurement (Non-Patent Literature 2). These methods can measure the thickness of the steel material immediately below the probe, but cannot inspect the groundside portion hidden in the ground or in concrete.

Several methods have been developed to inspect corrosion of groundside portion in the ground or in concrete. For example, there is a method in which an ultrasonic wave is applied to a steel pipe at the ground surface, propagates to an underground part, and is detected at a concrete surface part (Patent Literature 2). Also, a method of generating ultrasonic waves includes a method in which the electromagnetic ultrasonic wave is applied to the steel material at the upper part of the groundside portion by the ultrasonic generator composed of the high-frequency coil and the electromagnet described above, and by receiving the sound wave reflected through the steel pipe part buried in the ground, the corrosion occurring in its middle part is detected (Non-Patent Literature 3). Alternatively, an electromagnetic method includes a method in which an eddy current flaw detection sensor in which the lines of magnetic force spread more than those of conventional coils is used, and the depth of corrosion is estimated from an attenuation signal generated when the eddy current flaw detection sensor is perpendicularly set to the surface of a steel pipe and scans the surface toward a direction away from the groundside portion (Patent Literature 3). Alternatively, there is a method in which a magnetic core is provided between a steel pipe and the ground, and the eddy current measurement is performed with the magnetic core to measure corrosion of the steel pipe in a portion buried underground (Patent Literature 4).

### CITATION LIST

### Patent Literatures

Patent Literature 1: JP-B2 3924626 Gazette
Patent Literature 2: JP-B2 5900695 Gazette
Patent Literature 3: JP-A 2014-194382 Gazette
Patent Literature 4: JP-A 2017-096678 Gazette

### Non-Patent Literatures

Non-Patent Literature 1: Toshihiro Yamamoto, Welding and Nondestructive Testing Technology Center Technical Review, pp 10-19 (2016)
Non-Patent Literature 2: Keiji Tsukada, Yuta Haga, Koji Morita, et al., Detection of Inner Corrosion of Steel Construction Using Magnetic Resistance Sensor and Magnetic Spectroscopy Analysis, IEEE Transactions on Magnetics, vol. 52, 6201504 (2016)
Non-Patent Literature 3: Kazushige Homma, Corrosion Inspection Device for Buried Object of Street Lighting, IIC REVIEW, No. 33, pp 36-43 (2005)

### SUMMARY OF INVENTION

### Technical Problem

However, in the method using electromagnetic ultrasonic waves, it is known that a problem that a signal cannot be obtained due to poor contact when the part directly under the probe is corroded, or when the paint is swollen with rust is likely to occur. For this reason, in the method using electromagnetic ultrasonic waves, a pre-processing operation for preliminarily cleaning the corroded portion or the swollen painted portion on the surface of the measurement portion is required. In addition, the method using the eddy current method has a problem that it is impossible to measure a part deeply away from the groundside portion. Further, in the method using the eddy current method, there is a problem that sufficient accuracy cannot be obtained with the eddy current through the ground due to the influence of the water content and the density of the ground.

### Solution to Problems

The present invention has been proposed to solve the above-mentioned problem, and a non-destructive inspection device includes a magnetic probe including an application coil that applies a magnetic field to a to-be-inspected body erected on a ground, the to-be-inspected body having a base end buried in the ground, and a magnetic sensor that detects a response from the to-be-inspected body to the magnetic field applied by the application coil, a current source that supplies an AC current of a prescribed frequency to the application coil, a detector that detects an output signal from the magnetic sensor, and an analyzer that performs an analysis using the output signal of the detector.

In particular, in the non-destructive inspection device of the present invention, a response from the to-be-inspected body is detected with a first mode in which a magnetic field generated by the application coil is applied toward a groundside portion of the to-be-inspected body, and a second mode in which a magnetic field is applied to the to-be-inspected body by an application coil located at a position different from a position of the application coil for the first mode.

Furthermore, the non-destructive inspection device of the present invention includes a first magnetic probe that applies a magnetic field of the first mode and a second magnetic probe that applies a magnetic field of the second mode.

### Advantageous Effects of Invention

In the present invention, by applying the magnetic field generated by the application coil of the magnetic probe toward the groundside portion of the to-be-inspected body, the magnetic field can be extended to the area under the ground and the concrete around the to-be-inspected body, and it is possible to measure a change in the plate thickness of the to-be-inspected body in the buried portion that cannot be seen as it is because it is below the ground or concrete. In particular, it is possible to identify the position where the plate thickness changes by performing measurement in the first mode and the second mode in which the direction of application of the magnetic field or the target to be applied is different.

### BRIEF DESCRIPTION OF DRAWINGS

FIG. 1 is a schematic configuration diagram of a non-destructive inspection device according to the present invention.

FIG. 2 is a configuration diagram of a main part of the non-destructive inspection device according to the present invention.

FIG. 3 is a configuration diagram of a modification of a main part of the non-destructive inspection device according to the present invention.

FIG. 4 is a graph showing the dependence of the magnetic spectrum on corrosion depth obtained by a measurement test of a thinned test piece using one magnetic probe.

FIG. 5 is a graph showing the dependence of the magnetic signal intensity on corrosion depth using a difference vector of magnetic vectors obtained with an applied magnetic field of 20 Hz with the magnetic vector obtained with an applied magnetic field of 1 Hz as a reference vector.

FIG. 6 is a graph showing the dependence of the magnetic signal intensity on distance when the intersection angle formed by the surface of the test piece and the center axis of the application coil of the magnetic probe is set to 30 degrees and 45 degrees.

FIG. 7 is a graph showing the dependence of the magnetic signal intensity on distance when the intersection angle formed by the surface of the test piece and the center axis of the application coil of the magnetic probe is set to 30 degrees and 45 degrees.

FIG. 8 is a graph showing the dependence of the magnetic signal intensity on distance when the intersection angle formed by the surface of the test piece and the center axis of the application coil of the magnetic probe is set to 45 degrees.

### DESCRIPTION OF EMBODIMENTS

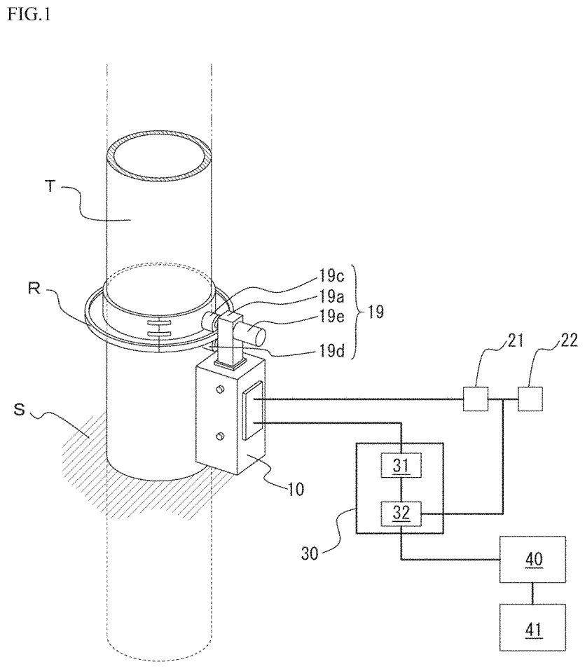

As shown in FIG. 1, the non-destructive inspection device of the present invention is a non-destructive inspection device that detects thinning of a groundside portion of a to-be-inspected body T erected on the ground by burying a base end in the ground. In FIG. 1, reference symbol S denotes the ground.

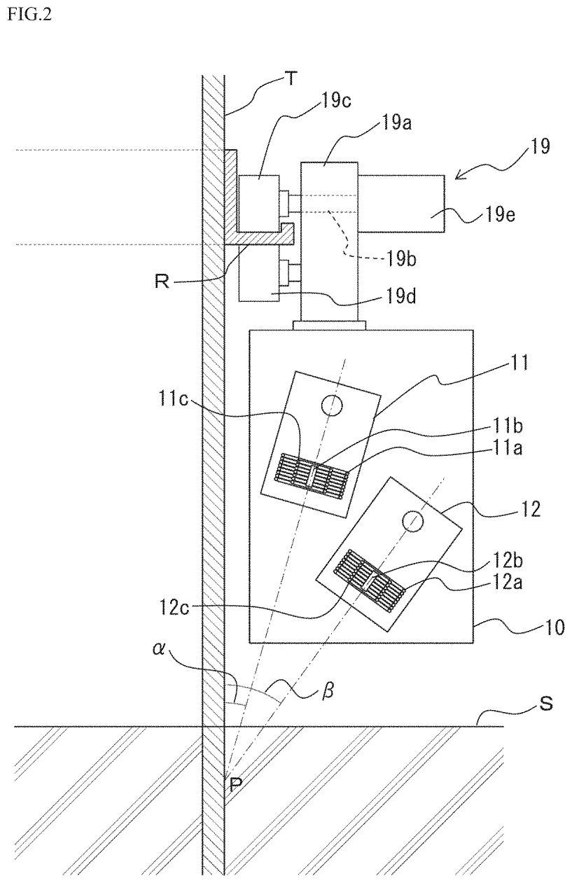

The non-destructive inspection device includes a magnetic probe having an application coil and a magnetic sensor (see FIG. 2), a current source 21 that supplies an AC current of a prescribed frequency to the application coil of the magnetic probe, a detector 30 that detects an output signal from the magnetic sensor of the magnetic probe, and an analyzer 40 that performs an analysis using the output signal of the detector 30. In FIG. 1, reference numeral 41 denotes a display device connected to the analyzer 40. In the present embodiment, as shown in FIG. 2, the magnetic probes 11 and 12 are mounted in a box-shaped probe holder 10.

The probe holder 10 can orbit around the to-be-inspected body T. In this embodiment, as shown in FIG. 1, the orbiting rail R is detachably mounted on the to-be-inspected body T at the predetermined height from the ground S, and a traveling mechanism 19 that travels on the orbiting rail R is provided above the probe holder 10, so that the probe holder 10 can be moved along the orbiting rail R.

In the present embodiment, the traveling mechanism 19 includes a support frame 19a protruding above the probe holder 10, a drive shaft 19b (see FIG. 2) protruding horizontally from the support frame 19a, a drive wheel 19c mounted on the drive shaft 19b and rotation driven, an auxiliary wheel 19d disposed to face the drive wheel 19c with the orbiting rail R interposed therebetween, and a drive motor 19e for rotating the drive shaft 19b.

In the traveling mechanism 19, the orbiting rail R is sandwiched between the drive wheel 19c and the auxiliary wheel 19d, and the magnetic probe 10 is movable along the orbiting rail R by rotating the drive wheel 19c. The orbiting rail R may also be provided with an origin mark at a predetermined position so that it is possible to detect that the traveling mechanism 19 has made one revolution along the orbiting rail R. Although not shown in FIG. 1, a control signal is input to the traveling mechanism 19 from the analyzer 40, and the traveling of the traveling mechanism 19 is controlled by the control of the analyzer 40.

The current source 21 is input an AC current of a prescribed frequency to each of the magnetic probes 11 and 12 in the probe holder 10 based on the frequency signal input from a frequency transmitter 22.

In the present embodiment, the detector 30 includes a magnetic sensor measurement circuit 31 to which signals output from the magnetic sensors of the magnetic probes 11 and 12 are input, and a lock-in detector 32 that detects the signal output from the magnetic sensor measurement circuit 31 based on the frequency signal output from the frequency transmitter 22.

The signal output from the lock-in detector 32 is input to an analyzer 40 which performs an analysis described later.

As described below, when providing two magnetic probes 11 and 12 in the probe holder 10, the current source 21, the frequency transmitter 22, the magnetic sensor measurement circuit 31, and the lock-in detector 32 may be connected to the magnetic probes 11 and 12 via appropriate switches. Alternatively, the current source 21, the frequency transmitter 22, the magnetic sensor measurement circuit 31, and the lock-in detector 32 may be provided for each of the magnetic probes 11 and 12.

In the present embodiment, as shown in FIG. 2, the first magnetic probe 11 and the second magnetic probe 12 are mounted in the probe holder 10.

The first magnetic probe 11 and the second magnetic probe 12 have built-in application coils 11a and 12a, and built-in magnetic sensors 11b and 12b, respectively. The application coils 11a and 12a are connected to the current source 21 via predetermined wiring (not shown), respectively. The magnetic sensors 11b and 12b are also connected to the magnetic sensor measurement circuit 31 via predetermined wiring (not shown), respectively.

The application coils 11a and 12a are provided on the distal ends of the first magnetic probe 11 and the second magnetic probe 12, respectively. The application coils 11a and 12a generate an eddy current in the to-be-inspected body T by generating an AC magnetic field.

The magnetic sensors 11b and 12b are provided at the center positions of the application coils 11a and 12a. The magnetic sensors 11b and 12b detect a magnetic field generated by an eddy current generated in the to-be-inspected body T.

Although the magnetic sensors 11b and 12b include a magnetoresistive element in the present embodiment, instead of the magnetoresistive element, can include an appropriate sensor having sensitivity from a low frequency, such as a tunnel-type resistance element (TMR), a magnetic impedance element (MI), and a superconducting quantum interference element (SQUID).

Furthermore, cancel coils 11c and 12c are provided coaxially inside the application coils 11a and 12a. In particular, it is desirable to dispose the magnetic sensors 11b and 12b at the center positions of the cancel coils 11c and 12c. The cancel coils 11c and 12c generates a magnetic field that is generated by the application coils 11a and 12a, and which cancels a magnetic field acting on the magnetic sensors 11b and 12b in the application coils 11a and 12a to reduce the influence of the application coils 11a and 12a on the magnetic sensors 11b and 12b. The magnetic sensors 11b and 12b may be disposed anywhere as long as the magnetic field induced in the to-be-inspected body T by the AC magnetic field generated by the application coils 11a and 12a can be detected.

In the present embodiment, the first magnetic probe 11 applies the magnetic field generated by the application coil 11a when the center axis of the application coil 11a is directed toward the vicinity of the groundside portion of the to-be-inspected body T. That is, the center axis of the application coil 11a and the outer surface of the to-be-inspected body T intersect at a predetermined angle α. Here, for convenience of explanation, the intersection between the center axis of the application coil 11a and the outer surface of the to-be-inspected body T is defined as P. Since the thinning occurring in the to-be-inspected body T often occurs slightly below the groundside portion, it is desirable that the intersection P is below the ground S, that is, underground, as shown in FIG. 2.

In this embodiment, although the angle α between the center axis of the application coil 11a and the outer surface of the to-be-inspected body T is about 30 degrees, any angle can be set according to the shape of the magnetic probe and the shape of the steel material of the to-be-inspected body T. Further, an angle adjusting mechanism may be provided so that the direction of the center axis of the application coil 11a can be adjusted.

As shown in FIG. 2, the second magnetic probe 12 adjusts the center axis of the application coil 12a so that the center axis of the application coil 12a and the outer surface of the to-be-inspected body T form an angle β larger than the angle α. That is, the second magnetic probe 12 applies a magnetic field to the to-be-inspected body T with the application coil 12a in a direction different from the direction in which the magnetic field is applied by the application coil 11a of the first magnetic probe 11. Here, in FIG. 2, the center axis of the second magnetic probe 12 is drawn so as to intersect with the outer surface of the to-be-inspected body T at the point P It is preferable that the center axis intersect at the same point P as much as possible. Further, in this case, the distance from the application coil 11a of the first magnetic probe 11 to the to-be-inspected body T and the distance from the application coil 12a of the second magnetic probe 12 to the to-be-inspected body T may be different.

In FIG. 2, although two magnetic probes of the first magnetic probe 11 and the second magnetic probe 12 are used, a position adjustment mechanism is provided, in which one magnetic probe may be moved to the position of the first magnetic probe 11, and the position of the second magnetic probe 12.

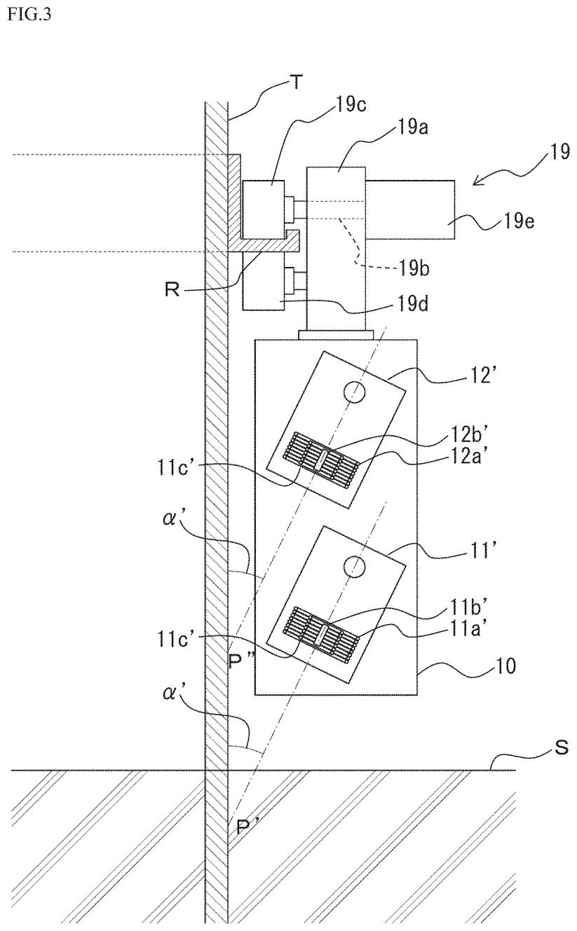

As another embodiment, as shown in FIG. 3, a first magnetic probe 11′ and a second magnetic probe 12′ may be disposed vertically with each other in a probe holder 10′.

Also in the this embodiment, the first magnetic probe 11′ applies a magnetic field generated by the application coil 11a′ with the center axis of the application coil 11a′ directed toward the vicinity of the groundside portion of the to-be-inspected body T. That is, the center axis of the application coil 11a′ and the outer surface of the to-be-inspected body T forms a predetermined angle α¥och′. Here, for convenience of explanation, the intersection between the center axis of the application coil 11a′ and the outer surface of the to-be-inspected body T is defined as P′. In FIG. 3, reference numeral 11b′ denotes a magnetic sensor of the first magnetic probe 11′, and reference numeral 11c′ denotes a cancel coil of the first magnetic probe 11′.

As shown in FIG. 3, the second magnetic probe 12′ has a predetermined height from the ground S in a state where the center axis of the application coil 12a′ intersects with the outer surface of the to-be-inspected body T at a predetermined angle α¥och′. In this case, the intersection P″ at which the center axis of the application coil 12a′ intersects with the outer surface of the to-be-inspected body T is away from the groundside portion of the to-be-inspected body T, but does not pose any problem in measurement. In FIG. 3, reference numeral 12b′ denotes a magnetic sensor of the second magnetic probe 12′, and reference numeral 12c′ denotes a cancel coil of the second magnetic probe 12′. In addition, in the first magnetic probe 11′ and the second magnetic probe 12′, the intersection angle formed by the center axis of each of the application coils 11a′ and 12a′ and the outer surface of the to-be-inspected body T is not necessarily the same, but it is desirable to be the same when possible.

In FIG. 3, although two magnetic probes of the first magnetic probe 11′ and the second magnetic probe 12′ are used, an up and down mechanism is provided in which one magnetic probe may be moved up and down to the position of the second magnetic probe 12′ and the position of the first magnetic probe 11′.

Hereinafter, an inspection method using the non-destructive inspection device of the present invention will be described.

In the non-destructive inspection device of the present invention, an eddy current is generated in the to-be-inspected body T by applying an AC magnetic field to the to-be-inspected body T from the application coil of the magnetic probe. For the AC magnetic field to be applied, it is possible to generate an appropriate AC magnetic field in accordance with the inspection, such as an AC magnetic field in which two or more AC frequencies are synthesized, or an AC magnetic field in which frequencies are switched over time.

An eddy current is generated in the to-be-inspected body T based on the applied AC magnetic field. The magnetic field generated by the eddy current is detected by a magnetic sensor, and is output as a detection signal from a magnetic sensor measurement circuit.

The detection signal output from the magnetic sensor measurement circuit is input to the lock-in detector, the lock-in detector detects, based on the frequency information signal input from the frequency transmitter, a real component signal of the detection signal having the same frequency as the frequency of the magnetic field applied by the application coil and having the same phase, and an imaginary component signal with the phase shifted by 90° and output them. In addition, instead of the lock-in detector, the time waveform of the detection signal is AD-converted, and the in-phase component and 90° phase component are digitally analyzed using a personal computer, etc., so that it is also possible to generate a real component signal and an imaginary component signal.

The real component signal and the imaginary component signal are input to an analyzer. The analyzer treats the signal as a magnetic field vector with the real component signal as a real component and the imaginary component signal as an imaginary component. Further, the analyzer generates difference vector data with respect to the reference vector with a magnetic field vector at any frequency as a reference vector.

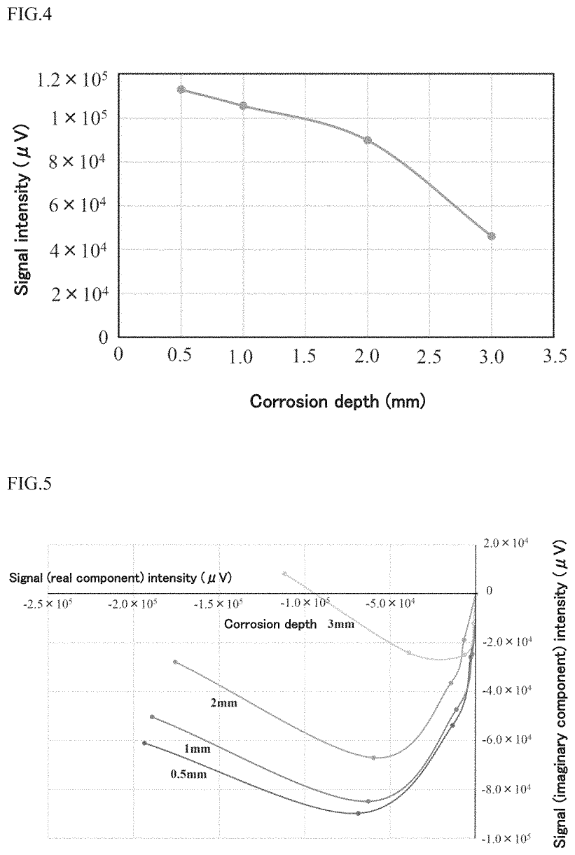

Here, for the 4 mm thick steel plate as a thinned sample body, test pieces whose thicknesses were reduced by grinding the rear surface of the steel plate with a width of 60 mm and a depth of 0.5 mm, 1 mm, 2 mm, and 3 mm, respectively, were used. FIG. 4 shows the result of the difference vector obtained by scanning each of these test pieces using one magnetic probe with the frequency of the applied magnetic field between 1 Hz and 100 Hz. Here, the reference vector is a magnetic field vector at 1 Hz. The center axis of the application coil of the magnetic probe is perpendicular to the surface of the test piece.

FIG. 4 shows a magnetic spectrum in which a magnetic field vector at each frequency is drawn on a two-dimensional plane of a real axis and an imaginary axis. As shown in FIG. 4, the magnitude of the magnetic spectrum changes according to the change in the thickness of the test piece, it can be seen that the signal is attenuated as the thickness of the test piece is thin, that is, as the thinning due to corrosion is large.

When the measurement by scanning is performed with the frequency of the applied magnetic field between 1 Hz and 100 Hz, the measurement time is relatively long. Thus, FIG. 5 shows the result of comparing the amount of change in signal intensity when, for example, the frequency of the applied magnetic field is set to 20 Hz with the frequency of the applied magnetic field set to 1 Hz as a reference. As shown in FIG. 5, also in this case, similarly to FIG. 4, a signal change due to the thickness of the test piece could be extracted. Moreover, the plate thickness change can be measured at two frequencies, indicating that the measurement can be performed in a shorter time.

Here, although the center axis of the magnetic application coil of the magnetic probe is perpendicular to the surface of the test piece, in the non-destructive inspection device of the present invention as mentioned above, the center axis of the magnetic application coil of the magnetic probe has a predetermined angle with the outer surface of the to-be-inspected body.

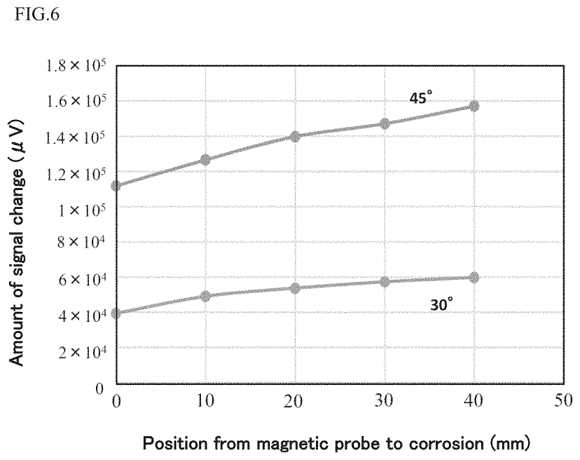

Therefore, using a test piece that has been ground 2 mm, the measurement was performed when the surface of this test piece and the center axis of the application coil of the magnetic probe intersect at 30 degrees, and when they intersect at 45 degrees. Here, the amount of change in signal intensity when the frequency of the applied magnetic field was set to 20 Hz was measured with the frequency of the applied magnetic field set to 1 Hz as a reference. Furthermore, the distance dependency when the distances of the magnetic probe from the test piece were set to 0 mm, 10 mm, 20 mm, 30 mm, and 40 mm, and the distance dependency was checked. FIG. 6 shows the results.

As shown in FIG. 6, since amount of change in the signal intensity changes as the magnetic probe moves away from the test piece, it can be understood that distance information from the magnetic probe to the thinned portion can be obtained. Also, it was confirmed that there was a difference in the signal intensity with respect to the angle formed by the center axis of the application coil of the magnetic probe and the to-be-inspected body.

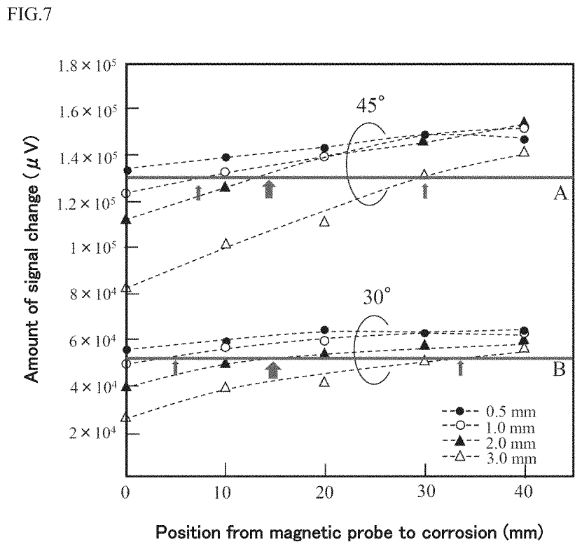

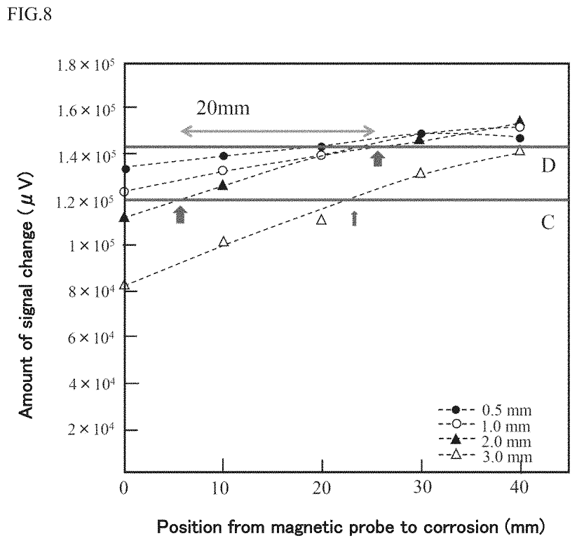

The test described above was performed using a test piece that had been ground by 2 mm, and FIG. 7 shows the results of similar tests on other test pieces. That is, the results when the surface of each test piece and the center axis of the application coil of the magnetic probe intersect at 30 degrees and when they intersect at 45 degrees are shown. The amount of change in signal intensity when the frequency of the applied magnetic field is 20 Hz is measured with the frequency of the applied magnetic field set to 1 Hz as a reference. Further, the distances of the magnetic probe from the test piece are set to 0 mm, 10 mm, 20 mm, 30 mm, and 40 mm.

In FIG. 7, when the intersection angle formed by an outer surface of the to-be-inspected body with respect to a given to-be-inspected body and the center axis of the magnetic application coil of the magnetic probe is 45 degrees, and the frequency of the applied magnetic field is set to 1 Hz as a reference, it is assumed that the amount of change in the signal intensity when the frequency of the applied magnetic field is 20 Hz is about 1.3×10⁵ μV (line A in FIG. 7). The to-be-inspected body T and the test piece are made of the same material.

In this case, the following three cases are conceivable from the relationship between the distance from the magnetic probe to the thinned portion and the amount of thinning.

1) The distance is 30 mm and the amount of thinning is 3 mm (the right end arrow in line A in FIG. 7).

2) The distance is 12 mm and the amount of thinning is 2 mm (the middle arrow in line A in FIG. 7).

3) The distance is 8 mm and the amount of thinning is 1 mm (the left end arrow in line A in FIG. 7).

Here, when the intersection angle formed by an outer surface of the to-be-inspected body with respect to a given to-be-inspected body and the center axis of the magnetic application coil of the magnetic probe is 30 degrees, and the frequency of the applied magnetic field is set to 1 Hz as a reference, in a case where the amount of change in the signal intensity when the frequency of the applied magnetic field is 20 Hz is about 5.2×10⁴ μV (line B in FIG. 7), the following three cases are conceivable from the relationship between the distance from the magnetic probe to the thinned portion and the amount of thinning.

1) The distance is 33 mm and the amount of thinning is 3 mm (the right end arrow in line B in FIG. 7).

2) The distance is 12 mm and the amount of thinning is 2 mm (the middle arrow in line B in FIG. 7).

3) The distance is 5 mm and the amount of thinning is 1 mm (the left end arrow in line B in FIG. 7).

From these two data, it can be determined that the thinned portion is located at a distance of 12 mm from the magnetic probe and has the amount of thinning of 2 mm.

The non-destructive inspection device of the present invention utilizes this. For example, measurement is performed as a first mode when the center axis of the magnetic application coil of the magnetic probe and the to-be-inspected body intersect at 30 degrees, and as a second mode when the center axis of the magnetic application coil of the magnetic probe and the to-be-inspected body intersect at 45 degrees, so that it is possible to determine the distance to the thinned portion occurring in the to-be-inspected body and the amount of thinning.

In particular, as shown in FIG. 2, inspection can be performed in a shorter time by performing the inspection by providing the first magnetic probe 11 for the first mode and the second magnetic probe 12 for the second mode. When the difference in accuracy between the first magnetic probe 11 and the second magnetic probe 12 is a concern, in the measurement may be performed by one magnetic probe and the probe position adjustment mechanism in which the position of the magnetic probe are made different between the first mode and the second mode.

In addition, not only in the method in which the position of the application coil is made different by making the direction of the center axis of the application coil different between the first mode and the second mode, but also in the method in which the position of the application coil itself is changed as shown in FIG. 3, the distance to the thinned portion occurring in the to-be-inspected body and the amount of thinning can be determined.

As in the graph of FIG. 7, FIG. 8 is a graph of the result of measurement in which in a case where the surface of each test piece and the center axis of the magnetic application coil of the magnetic probe intersect at 45 degrees, the amount of change in signal intensity when the frequency of the applied magnetic field is 20 Hz with the frequency of the applied magnetic field set to 1 Hz as a reference is measured, and further, the distances of the magnetic probe from the test piece are 0 mm, 10 mm, 20 mm, 30 mm, and 40 mm.

When the intersection angle formed by an outer surface of the to-be-inspected body for a given to-be-inspected body and the center axis of the magnetic application coil of the magnetic probe is 45 degrees, and the frequency of the applied magnetic field is set to 1 Hz as a reference, it is assumed that the amount of change in the signal intensity when the frequency of the applied magnetic field is 20 Hz is about 1.2×10⁵ μV (line C in FIG. 8).

In this case, the following two cases are conceivable from the relationship between the distance from the magnetic probe to the thinned portion and the amount of thinning.

1) The distance is 22 mm and the amount of thinning is 3 mm (the right arrow in line C in FIG. 8).

2) The distance is 5 mm and the amount of thinning is 2 mm (the left arrow in line C in FIG. 8).

Here, when the position of the magnetic probe is away from the position of the ground S, for example, the position of the magnetic probe is moved upward by about 20 mm, and the frequency of the applied magnetic field is set to 1 Hz as a reference, it is assumed that the value obtained by measuring the amount of change in the signal intensity when the frequency of the applied magnetic field is 20 Hz is about 1.42×10⁵ μV (line D in FIG. 8).

Here, while in case 1) above, there is no data that intersects with line D at a distance of about 42 mm, which is the sum of the distance of 22 mm and the movement amount of the magnetic probe of about 20 mm, in case 2) above, the line D intersects with the data of the amount of thinning of 2 mm near at a distance of about 25 mm, which is the sum of the distance of about 5 mm and the movement amount of the magnetic probe of about 20 mm, so that the thinned portion can be determined to be case 2).

The non-destructive inspection device shown in FIG. 3 utilizes this. For example, measurement is performed as a first mode when the magnetic application coil of the magnetic probe is closest to the ground S, and measurement is performed as a second mode when the magnetic probe is moved above the position of the magnetic probe in the first mode, so that it is possible to determine the distance to the thinned portion occurring in the to-be-inspected body and the amount of thinning.

In particular, as shown in FIG. 3, inspection can be performed in a shorter time by performing the inspection by providing a first magnetic probe 11′ for the first mode and a second magnetic probe 12′ for the second mode. When the difference in accuracy between the first magnetic probe 11′ and the second magnetic probe 12′ is a concern, in the measurement may be performed by one magnetic probe and the probe position adjustment mechanism in which the position of the magnetic probe are made different between the first mode and the second mode.

As mentioned above, in the non-destructive inspection device of the present invention, an analysis is performed using the strength and phase of each magnetic component obtained by detecting or analyzing the output of the magnetic sensor obtained at two or more frequencies at each angle by changing the angle of the magnetic probe and, so that it is possible to determine the amount of thinning and the depth position of a portion where thinning has occurred due to corrosion. Alternatively, an analysis is performed using the strength and phase of each magnetic component obtained by detecting or analyzing the output of the magnetic sensor at two or more frequencies by changing the distance of the magnetic probe from the measurement target location, so that it is possible to determine the amount of thinning and the depth position of a portion where thinning has occurred due to corrosion.

In addition, there are various types of steel which is the to-be-inspected body, and the amount of thinning and depth position of each corrosion for these materials are stored in a database in advance, and a calibration curve of the change in the magnetic signal due to angle or distance is prepared in advance, so that it is possible to more accurately determine the amount of thinning due to corrosion and the derived depth position.

The present invention is not limited to the above embodiments, and it goes without saying that various modifications and design changes within the technical scope of the present invention are included in the technical scope. For example, in this embodiment, a steel material is described as an example, but any metal such as stainless steel, copper, aluminum, or titanium, which is nonmagnetic, can be applied. In addition, the present invention can be applied not only to an object buried underground but also to an object hidden by a wall, a protective material, and the like.

### INDUSTRIAL APPLICABILITY

Since the present invention can be widely used for detecting defects such as corrosion of hidden parts such as the groundside portion of a metallic structure, it can be used not only in the social infrastructure fields such as vertical materials such as bridges, diagonal materials, and lighting tower supports, which were difficult to inspect in the past, but also in industrial fields such as piping and storage tanks in chemical plants.

### REFERENCE SIGNS LIST

10 Probe holder
11, 11′ Magnetic probe
11a, 11a′ Application coil
11b, 11b′ Magnetic sensor
11c, 11c′ Cancel coil
12, 12′ Magnetic probe
12a, 12a′ Application coil
12b, 12b′ Magnetic sensor
12c, 12c′ Cancel coil
19 Travel mechanism
21 Current source
22 Frequency transmitter
30 Detector
31 Magnetic sensor measurement circuit
32 Lock-in detector
40 Analyzer
41 Display device
T To-be-inspected body
S Ground
R Orbiting rail

1. A non-destructive inspection device comprising:
a magnetic probe including an application coil that applies a magnetic field to a to-be-inspected body erected on a ground, the to-be-inspected body having a base end buried in the ground, and a magnetic sensor that detects a response from the to-be-inspected body to the magnetic field applied by the application coil;
a current source that supplies an AC current of a prescribed frequency to the application coil;
a detector that detects an output signal from the magnetic sensor; and
an analyzer that performs an analysis using the output signal of the detector,
wherein a response from the to-be-inspected body is detected with
a first mode in which a magnetic field generated by the application coil is applied toward a groundside portion of the to-be-inspected body, and
a second mode in which a magnetic field is applied to the to-be-inspected body by an application coil located at a position different from a position of the application coil for the first mode, the frequencies of the magnetic field applied in the first mode and the second mode are two frequencies: a predetermined reference frequency and a frequency different from the reference frequency.

2. The non-destructive inspection device according to claim 1, wherein a direction of a center axis of the application coil for the second mode is different from a direction of a center axis of the application coil for the first mode.

3. The non-destructive inspection device according to claim 1, wherein a height of the application coil for the second mode from the ground is different from a height of the application coil for the first mode from the ground.

4. The non-destructive inspection device according to claim 1, further comprising:
a first magnetic probe that applies a magnetic field of the first mode; and
a second magnetic probe that applies a magnetic field of the second mode.

5. The non-destructive inspection device according to claim 2, further comprising:
a first magnetic probe that applies a magnetic field of the first mode; and
a second magnetic probe that applies a magnetic field of the second mode.

6. The non-destructive inspection device according to claim 3, further comprising:
a first magnetic probe that applies a magnetic field of the first mode; and
a second magnetic probe, that applies a magnetic field of the second mode.
